(19) United States
(12) Patent Application Publication
(10) Pub. No.: US 2008/0026263 A1
(43) Pub. Date: Jan. 31, 2008

(54) Startup circuit for electronics in a hazardous environment

(76) Inventors: David A. Leboe, Vancouver (CA); Minjie Shi, Burnaby (CA)

Correspondence Address: TROP PRUNER & HU, PC, 1616 S. VOSS ROAD, SUITE 750, HOUSTON, TX, 77057-2631, US

(21) Appl. No.: 11/821,731

(22) Filed: Jun. 25, 2007

Related U.S. Application Data
(60) Provisional application No. 60/806,056, filed on Jun. 28, 2006.

(51) Int. Cl. H01M 8/04

(52) U.S. Cl. 429/13; 429/22

(57) ABSTRACT

A fuel cell system includes a first subsystem that is classified to operate in a hazardous environment and a second subsystem that is classified to operate in a hazardous environment. The second subsystem includes a sensor to detect inflammable gas, and the second subsystem is adapted to control communication of power to the first subsystem based on whether the second subsystem detects a concentration of the flammable gas exceeding a predefined threshold.

This application claims the benefit under 35 U.S.C. § 119(e) to U.S. Provisional Patent Application Ser. No. 60/806,056 entitled, “ELECTRONICS CIRCUIT FOR HAZARDOUS ENVIRONMENT,” which was filed on Jun. 28, 2006, and is hereby incorporated by reference in its entirety.

### BACKGROUND

The invention generally relates to a startup circuit for electronics in a hazardous environment.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange membrane (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C.) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:
H₂→2H⁺+2e⁻ at the anode of the cell, and Equation 1
O₂+4H⁺+4^{e}^{u-}→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Catalyzed electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In an embodiment of the invention, a system includes a first subsystem that is not classified to operate in a hazardous environment and a second subsystem that is classified to operate in a hazardous environment. The second subsystem includes a sensor to detect flammable gas, and the second subsystem is adapted to control communication of power to the first subsystem based on whether the second subsystem detects a concentration of the flammable gas exceeding a predefined threshold.

In another embodiment of the invention, a technique that is usable with a fuel cell-based system includes providing a first subsystem that is not classified to operate in a hazardous environment and providing a second subsystem that is classified to operate in a hazardous environment. The second subsystem is used to detect a flammable gas and control the communication of power to the first subsystem based on a concentration of the flammable gas detected by the second subsystem.

Advantages and other features of the invention will become apparent from the following drawing, description and claims.

### BRIEF DESCRIPTION OF THE DRAWING

FIG. 1 is a schematic diagram of a fuel cell-based system according to an embodiment of the invention.

FIGS. 2, 4 and 6 are schematic diagrams depicting certain aspects of an electrical subsystem of the system according to embodiments of the invention.

FIG. 3 is a flow diagram depicting a technique to start up and shut down the electrical subsystem of FIG. 2 according to an embodiment of the invention.

FIG. 5 is a flow diagram depicting a technique to start up and shut down the electrical subsystem of FIG. 4 according to an embodiment of the invention.

FIG. 7 is a flow diagram depicting a technique to start up and shut down the electrical system of FIG. 6 according to an embodiment of the invention.

### DETAILED DESCRIPTION

A fuel cell-based system may potentially be a hazardous location, and in accordance with this recognition, embodiments of fuel cell systems are disclosed herein for use in hazardous locations. Hazardous locations may be classified by classes and zones. In the context of this application, the fuel cell systems are designed for class one, which is the class for flammable gases.

Zone zero refers to an environment where ignitable concentrations of flammable gases, vapors or liquids are present continuously or for long periods of time under normal operating conditions. Zone one refers to an environment where ignitable concentrations of flammable gases, vapors or liquids are likely to exist under normal operating conditions. Zone two refers to an environment where ignitable concentrations of flammable gases, vapors or liquids are not likely to exist under normal operating conditions.

Each zone is associated with specific protection measures or design requirements. For example, for zone two, electrical protection techniques include using devices that are non-sparking, energy limited, hermetically sealed, non-incentive, etc. Some components such as large batteries and sparking components do not meet the classification requirements and therefore, must be de-classified by means of ventilation, detection or other techniques to ensure that the environment remains free of flammable gas. The fuel cell-based systems that are described herein contain both unclassified and classified subsystems. In accordance with embodiments of the invention that are described herein, in order for the unclassified subsystem to startup, a ventilation fan to de-classify the unclassified subsystem is started up only after the classified system determines (by a sensor, for example) a flammable atmosphere does not exist.

Designing and qualifying components for classified environments may present various challenges, such as increased component costs and certification costs. For this reason, the fuel cell systems that are described herein have a combination of classified and unclassified components.

Because the anode chamber may be purged and/or the stack may potentially leak during normal operation, flammable concentrations may be present at start-up of the fuel cell-based system or during the system's normal operation. To limit the extent of classified circuitry that is required for safe operation, a circuit for a fuel cell-based system that uses both unclassified and classified components is described herein in accordance with embodiments of the invention. Using this concept, a flexibility is provided to design the classified components to operate either in zone one or zone zero with minimal impact on the product design.

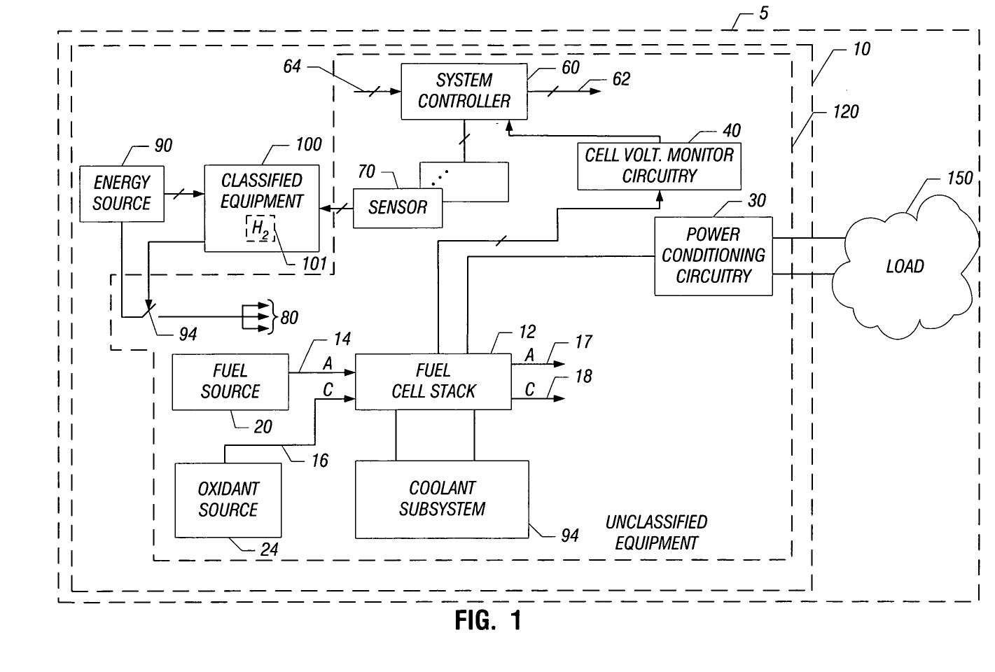

Referring to FIG. 1, an embodiment of a fuel cell-based system 10 in accordance with the invention includes a fuel cell stack 12, which generates electrical power for an external load 150. The load 150 may be, as examples, the electrical components of an automobile, a residential load, a commercial load, etc. In general, the fuel cell stack 12 receives an incoming fuel flow at its anode inlet 14 from a fuel source 20. The fuel source 20 may be, as examples, a container of hydrogen, a reformer, etc. The fuel flow is routed through the anode flow channels of the fuel cell stack 12 to promote electrochemical reactions inside the stack 12 for purposes of generating electrical power. In accordance with some embodiments of the invention, the fuel flow may produce a continuous exhaust at an anode outlet 17 of the fuel cell stack 12. It is noted that in other embodiments of the invention, the anode chamber of the fuel cell stack 12 may not have a continuous exhaust and thus, may be “dead-ended,” or “dead-headed,” which means the anode chamber is generally closed (and thus, does not have a continuous anode exhaust), with the anode chamber being intermittently purged to remove inert gases from the chamber.

The fuel cell stack 12 receives an oxidant flow at its cathode inlet 16 from an oxidant source 24, which may be, for example, an air blower or compressor. The oxidant flow is communicated through the cathode flow channels of the stack 12 for purposes of promoting electrochemical reactions inside the stack 12. In accordance with some embodiments of the invention, the cathode exhaust appears at a cathode outlet 18.

The electrical power that is generated by the fuel cell stack 12 is typically in the form of a DC stack voltage, which is received by power conditioning circuitry 30 and transformed into the appropriate AC or DC voltage for the load 150, depending on the particular application. In this regard, the power conditioning circuitry 30 may include, as examples, one or more switching converter stages, an inverter, etc., as can be appreciated by those skilled in the art.

In accordance with some embodiments of the invention, the system 10 and load 150 may be portable, or mobile, and more particularly may be (as an example) part of a motor vehicle 5 (a car, truck, airplane, etc.). Thus, the system 10 may serve as at least part of the power plant of the vehicle. In other embodiments of the invention, the system 10 and load 150 may be part of a stationary system. For example, the system 10 may supply all or part of the power needs of a house, electrical substation, backup power system, etc. Additionally, the system 10 may supply thermal energy to a thermal energy consuming load (water heater, water tank, heat exchanger, etc.), and thus, electrical as well as thermal loads to the system are also envisioned. Therefore, many different applications of the system and loads that consume energy from the system are contemplated and are within the scope of the appended claims.

Due to the presence of fuel (hydrogen, for example) in the system 10, the environment in which the system 10 operates may be considered a potentially flammable or hazardous environment. For example, the environment may be classified as a class one, zone two environment. Thus, care must be undertaken to ensure that any unclassified electrical infrastructure of the system 10 is not energized or operated in the potential presence of a flammable concentration of gas. One approach is to ensure that all electrical components of the system 10 are “classified,” which means that the components are each safe to start up in the presence of a flammable concentration of gas. However, an approach in accordance with the invention includes the use of both classified equipment 100 (i.e., classified to operate in a hazardous environment) and unclassified equipment 120 (i.e., not classified to operate in a hazardous environment), which are controlled pursuant to a technique to ensure that the system 10 may be started up and operated safely.

In general, in the context of the application, a “hazardous environment” means an environment in which the concentration (or other measure) of a flammable gas (such as hydrogen, for example) exceeds a predetermined threshold. The “hazardous environment” includes environments in which a flammable concentration of gas is present, as well as environments in which a flammable concentration of gas is not present.

More specifically, in accordance with some embodiments of the invention, upon the start up of the system 10, the system 10 controls the communication of electrical power from an energy source 90, which, should a gas concentration below a predefined threshold be detected, supplies electrical power to the classified 100 and unclassified 120 equipment of the system 10. The energy source 90 may be, as examples, a battery that is charged during normal operation of the system 10 and/or may be an energy source (such as a wall AC source, for example) that is independent of the operation of the system 10 altogether. The particular form of the energy source 90 is not important to the aspects of the invention that are described herein.

The classified equipment 100 receives the power from the energy source 90 upon start up and controls the communication of power from the energy source 90 to the unclassified equipment 120 such that the unclassified equipment 120 is not powered up should the classified equipment 100 detect a concentration of flammable of gas exceeding a predetermined threshold. As an example, the predetermined threshold may be a percentage, such as twenty-five percent (as a non-limiting example), of the Lower Flammability Limit (LFL). The LFL of hydrogen is four percent hydrogen in air. Therefore, for embodiments of the invention in which the classified equipment 100 monitors the concentration of hydrogen gas, a predetermined threshold of twenty five percent of the LFL (as an example) for hydrogen means that the classified equipment 100 monitors the concentration of hydrogen in air to detect when the hydrogen gas concentration exceeds one percent. The percentage of the LFL that is used to establish the predetermined threshold may vary, depending on the particular embodiment of the invention.

Thus, at start up from a powered-down state, the classified equipment 100 is first powered up and has the ability to detect flammable gas in the vicinity of a detector, such as a hydrogen detector 101. The major unclassified system electronics are at this point completely disengaged from any source of energy. If the detector 101 of the classified equipment 100 detects a hazardous condition (which may be due to a flammable gas concentration hazard or other fault, as described herein), the equipment 100 does not allow power to be communicated from the energy source 90 to the unclassified equipment, and the classified equipment 100 also powers down.

If, however, the classified equipment 100 fails to detect any hazardous condition, the classified equipment 100 closes a power transfer switch 94 for purposes of allowing communication of power from the energy source 90 to the power system bus 90, which supplies power to the unclassified equipment 120.

The unclassified equipment 120 includes a system controller 60, which as its name implies, generally controls the operations of the system 10. In this regard, the system controller 60 includes various input lines 64 and output lines 62 for purpose of controlling valves, motors, currents, voltages and sensing various parameters from the system 10. In accordance with some embodiments of the invention, the system controller 60 may monitor the output of the flammable gas detector of the classified equipment 100 to ensure overall safe operation of the system 10. Once energized and active, the system controller 60 gains the ability to de-energize the entire fuel system 10 including the classified 100 and unclassified equipment, as further described below.

At any time during its operation, should the classified equipment 100 detect a predetermined hazard level, the equipment 100 may also de-energize the entire system 10, including all of the classified equipment 100 and the unclassified equipment 120.

Thus, the energization of the unclassified equipment 120 is cascaded with the energization of the classified equipment 100. In other words, the unclassified equipment 120 cannot be energized without the classified equipment 100 being energized and active. In this way, the system 10 may be de-energized by de-energizing the primary, classified equipment 100 only. It is noted that in order to de-energize the classified equipment 100, the unclassified equipment 120 may only de-energize itself, with the classified equipment 100 being de-energized as a consequence. Thus, the architecture that is described herein presents a simple way to control the state of the unclassified equipment 120 by a single circuit.

Among the other features of the system 10, in accordance with some embodiments of the invention, the unclassified equipment 120 of the system 10 may include various additional equipment, such as sensors 70 to sense various currents, voltages, pressures, etc. and provide these indications to the system controller 60 as well as to the classified equipment 100. The unclassified equipment 120 may also include a cell voltage monitoring circuit 40, which scans the cell voltages of the fuel cell stack 12 for purposes of providing statistical information and measured cell voltages to the system controller 60. In other embodiments of the invention, the unclassified equipment 120 does not include the cell voltage monitoring circuit 40 and may, for example, include an analog circuit to measure the stack voltage. Additionally, in accordance with some embodiments of the invention, the system 10 may include a coolant subsystem 94, which circulates a coolant through the coolant channels of the fuel cell stack 12 for purposes of regulating the stack's temperature.

It is noted that the system 10 is depicted as merely an example of one out of many possible implementations of a fuel cell system in accordance with embodiments of the invention. Thus, many variations are contemplated and are within the scope of the appended claims.

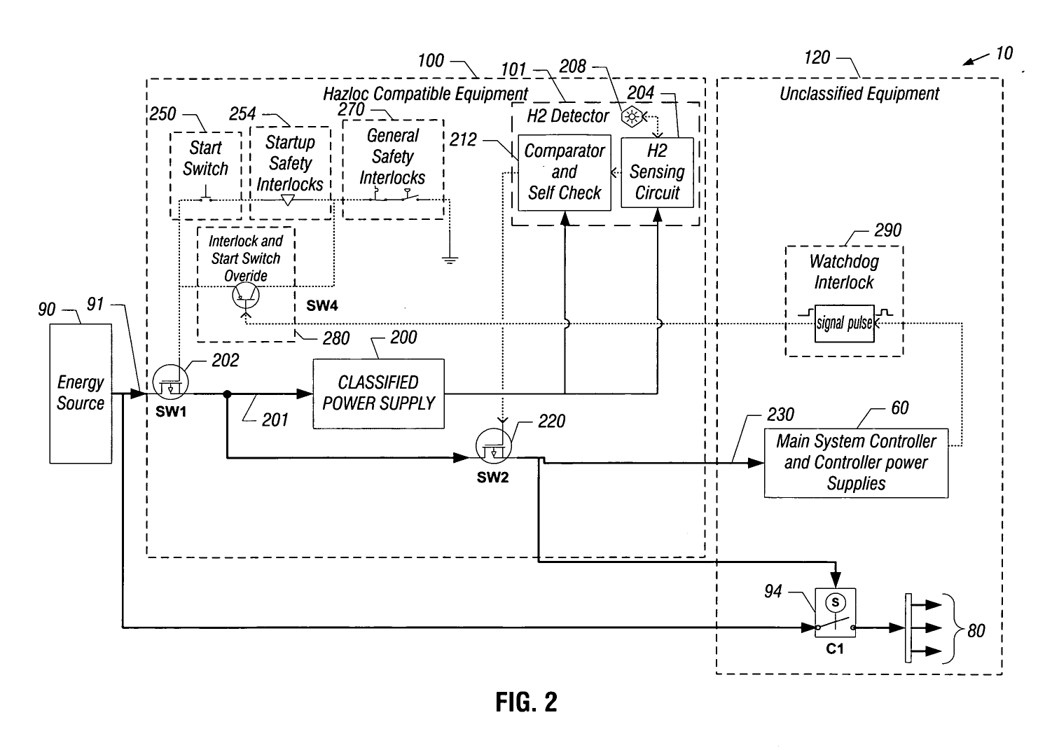

As a more specific example, FIG. 2 depicts an embodiment of the electrical subsystem of the system 10 according to some embodiments of the invention. In general, the classified equipment 100 includes a switch 202 (a metal-oxide-semiconductor field-effect-transistor (MOSFET), as an example), which controls the communication of electrical power from the energy source 90 to a power input terminal 201 of a classified power supply 200. In this regard, the controlled path of the switch 202 is electrically coupled between electrical terminals 91 of the energy source 90 and the input terminal 201 of the power supply 200. In general, the power supply 200 is a limited power supply source, which is classified to operate in a flammable concentration of gas and is configured to supply power only to the components of the classified equipment 100. The power supply 200 may alternately be designed in accordance to any protection method suitable for the designated zone (non-sparking, etc.)

In the shut down state of the system 10, the switch 202 is open, thereby isolating the classified equipment from the energy source 90. However, the switch 202 is closed when a user operable start switch 250 is depressed and other safety conditions being satisfied. In particular, in accordance with some embodiments of the invention in which the switch 202 is a MOSFET, the gate terminal of the switch 202 is electrically coupled to ground through a series of switches, one of which includes the start switch 250. Other switches are coupled in series with the start switch 250, which include start up safety interlocks and general safety interlocks 270 (interlocks indicative of a battery exceeding a maximum temperature threshold, a tilted position of the system, fire or overtemperature in hydrogen storage area, a low pressure condition and/or a high pressure condition, as just a few examples). When all of the switches are closed, the switch 202 is activated, i.e., closed, for purposes of communicating power from the energy source 90 to the power supply 200.

When energized, the power supply 200 furnishes electrical power to a hydrogen sensing circuit 204 and a comparator and self check circuit 212 of the classified equipment 100. The hydrogen sensing circuit 204 is electrically coupled to a hydrogen detector 208 for purposes of sensing a level of hydrogen gas in proximity to the hydrogen detector 208. The results of this sensing are compared by the comparator and self check circuit 212, which also performs a self check analysis of the flammable gas detector. The comparator and self check circuit 212, hydrogen sensing circuit 204 and the hydrogen sensor 208 may collectively form an embodiment of the hydrogen detector 101 (see FIG. 1) in accordance with some embodiments of the invention.

If the circuit 212 determines that a hazardous condition does not exist and the equipment 100 passes the self check, then the circuit 212 closes a switch 220. As depicted in FIG. 2, the switch 220 controls the communication of power from the terminal 201 to the unclassified equipment 120. In accordance with some embodiments of the invention, the switch 220 may be a MOSFET, which has its gate terminal coupled to the circuit 212.

When the switch 220 closes, electrical power is communicated from the energy source 90 to a control terminal of a solenoid-based switch 94. The switch 94, in turn, controls the communication of power between the energy source 90 and a system power distribution bus 80, which furnishes power to all of the components of the unclassified equipment 120. The closing of the switch 220 also electrically couples the energy source 90 to a power supply terminal 230 of the main system controller 60.

The system controller 60 performs various functions related to the control of the system 10. The system controller 60 may also supply a “heartbeat,” or pulse signal, to a watchdog interlock 290. The watchdog interlock 290, in general, asserts (drives low, for example) a signal that is supplied to control a switch 280, which latches the switch 202 closed. More specifically, as long as the watchdog interlock 290 receives the pulse signals from the main system controller 60 (indicating that the controller 60 is active), the watchdog interlock 290 maintains the state of its output signal to keep the switch 202 closed. If, however, the system controller 60 fails to supply the train of pulses to the watchdog interlock 290, the watchdog interlock 290 de-asserts (drives high or floats, as examples) its output signal to the controller 60 is assumed to be shut down or locked up, and to cause the switches 280 and 202 to open. This action, in turn, removes power from both the classified 100 and the unclassified 120 equipment, and the entire system is de-energized.

As depicted in FIG. 2, in accordance with embodiments of the invention, the switch 280 may be a bipolar junction transistor (BJT) that has its collector-to-emitter path coupled between the general safety interlocks 270 and the gate terminal of the switch 202 and ground. Thus, when the switch 280 is closed, the start switch 250 may be released by the user, as the effective short provided by the switch 280 maintains the switch 202 closed. However, when the switch 280 opens, the switch 202 also opens to thereby power down the unclassified 120 and classified 100 equipment.

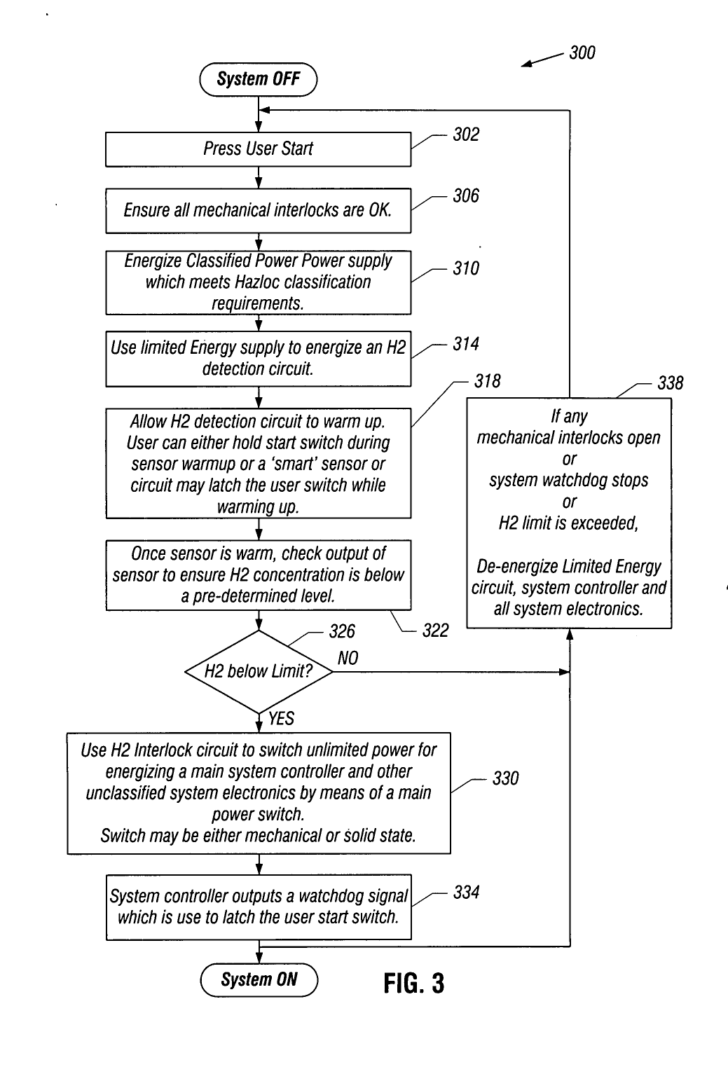

Referring to FIG. 3 in conjunction with FIG. 2, in accordance with embodiments of the invention, a technique 300 may be used to power up the electrical infrastructure depicted in FIG. 2 in accordance with some embodiments of the invention. The technique 300 assumes that the system is initially in an off, or shut down, state. Pursuant to the technique 300, to start up the system, the user depresses the start switch 250, pursuant to block 302. Next, the system 10 ensures that all mechanical interlocks are in the appropriate states, pursuant to block 306. The power supply 200 is then energized, pursuant to block 310, and the power supply 200 is used (block 314) to supply energy to the hydrogen sensor 208 and circuits 204 and 212.

Pursuant to block 318, the hydrogen detection circuitry is then allowed to warm up. The user may either hold the start switch 250 during the sensor warmup or, alternatively, a “smart” sensor or other circuit may latch the user switch while warming up. Once the sensor 208 is warm, the technique 300 includes checking (block 322) the output signal that is provided by the sensor 208 to ensure that the hydrogen concentration is below a predetermined level. If the hydrogen is determined (diamond 326) to be below the limit, then the switch 220 is closed to couple the energy source 90 to the unclassified equipment 120. The system controller 60 then furnishes the watchdog signal, which is used to latch the user start switch, pursuant to block 334. If the detected hydrogen concentration is above the predetermined threshold pursuant to the determination in diamond 326, then the switches 220 and 202 are open, which removes power from the classified 100 and unclassified 120 equipment. The same results apply if any mechanical interlocks are open or if the system watchdog signal is de-asserted.

In accordance with some embodiments of the invention, the sensor 208 defaults to a high reading until the sensor 208 is warmed up and is providing an accurate signal. For example, the sensor 208 may initialize its output signal above a cut-out threshold in accordance with some embodiments of the invention until the sensor 208 has warmed up and produces a valid signal.

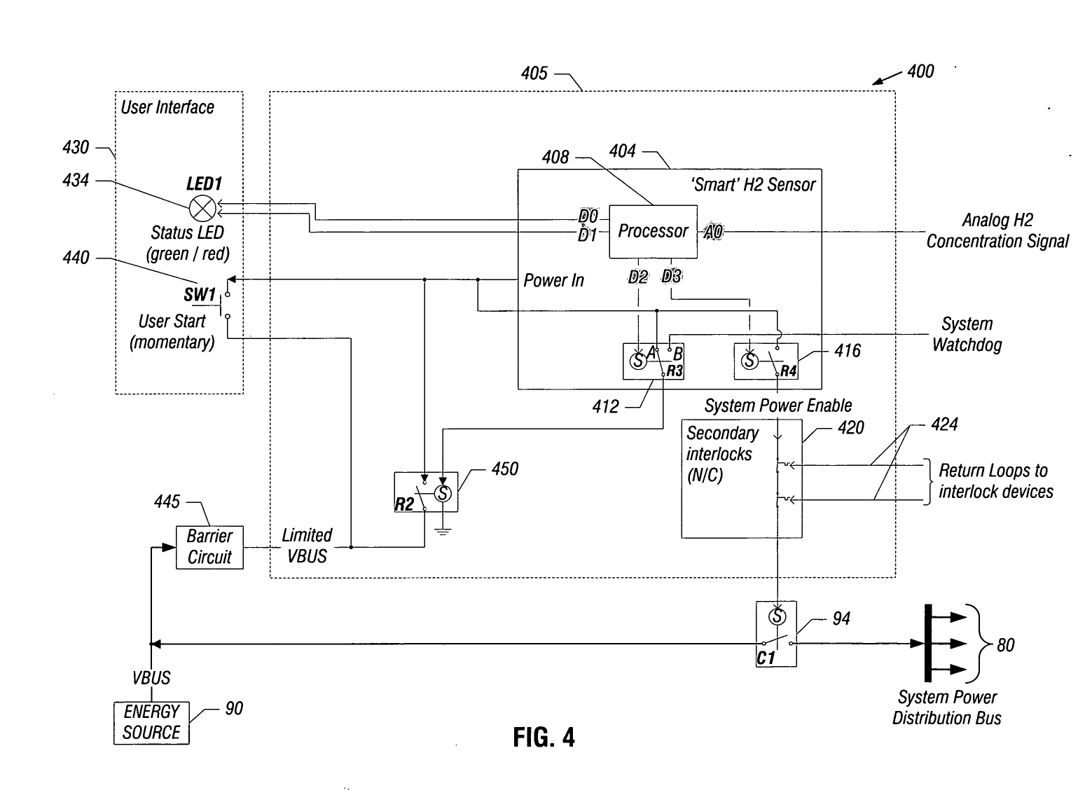

FIG. 4 depicts an alternative electrical subsystem 400 in accordance with embodiments of the invention. The electrical subsystem 400 includes classified equipment 405, which includes a “smart” hydrogen sensor 404. The smart hydrogen sensor 404 includes a processor 408 and relays 412 and 416. In general, the relay 412 controls the state of a relay 450, which controls the connection of a limited power supply 445 to the input power lines of the smart hydrogen sensor 404. Depending on the state of the relay 412, the relay 450 is controlled by either the system watchdog signal or a user switch 450 of a user interface 430. The user interface 430 may also include status light emitting diodes (LEDs) 434, which indicate by their color the status of the startup or shutdown of the fuel cell system.

As further described below, the subsystem 400 includes a relay 94, which controls the communication of electrical power between the system power distribution bus 80 and the main energy source 90. Furthermore, the subsystem 400 includes secondary interlocks 420, which are connected with the switch path of a relay 416 between the input power to the hydrogen sensor 404 and the control input of the relay 94.

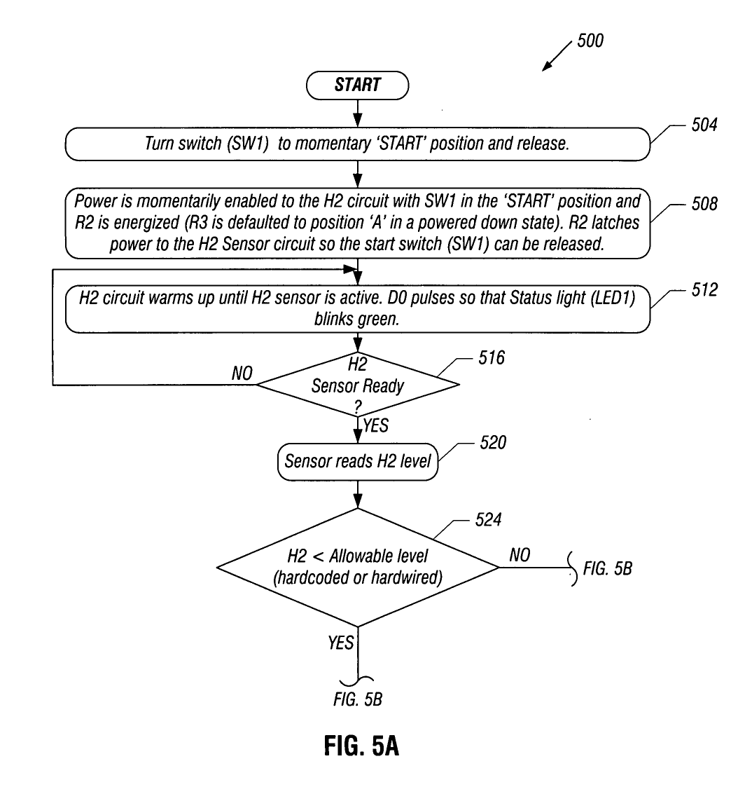

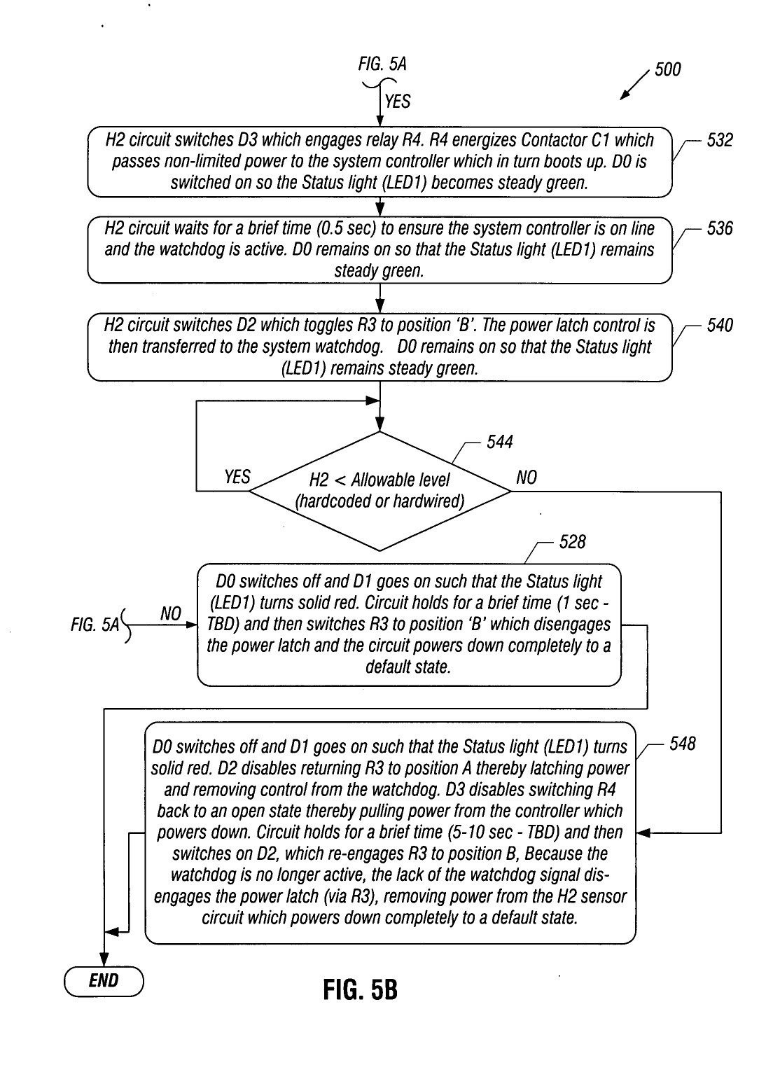

Referring to FIG. 5 in conjunction with FIG. 4, the subsystem 400 may function pursuant to a technique 500 in accordance with some embodiments of the invention. First, pursuant to the technique 500, the switch 40 is depressed (block 504) to a momentary “start” position and released. As depicted in block 508, due to this momentary action of the switch 440, power is momentarily enabled to the hydrogen sensor 404 with the switch 440 in the start position, and the relay 450 is energized (i.e., the relay 412 is defaulted to position “A” in the powered down state). The relay 450 latches power to the hydrogen sensor 404 so that the start switch 440 may be released.

The hydrogen sensor 404 warms up until the hydrogen sensor 404 is active, as depicted in block 512. At this point, the processor 408 pulses a signal called “D0” so that status LEDs 434 blink green. If the hydrogen sensor 404 is not ready (pursuant to diamond 516), then control returns to block 512. Otherwise, the hydrogen sensor 404 reads the hydrogen level pursuant to block 520. If it is determined that the hydrogen concentration is below an allowable level (pursuant to diamond 524), then the hydrogen sensor 404 asserts a signal called “D3” to engage the relay 416. The relay 416 then energizes the relay 94, to close the relay 94 such that power is communicated from the energy source 90 to the system power distribution bus 80. The processor 408 also asserts the DO signal so that the status LEDs 434 indicate steady green.

If, however, the hydrogen level is above the acceptable level, pursuant to diamond 524, then the processor 408 performs the actions that are set forth in block 528. In particular, the processor 408 de-asserts the DO signal and asserts a signal called “D1” such that the status LED 434 turns solid red. The processor 408 holds for a brief time (one second, for example) and then switches the relay 412 to position “B” to disengage the relay 450 and to allow the hydrogen sensor 404 to power down completely to a default state.

Assuming that the hydrogen is below the acceptable level (as described in block 524) and the actions set forth in block 532 are performed, the hydrogen sensor 404 waits for a brief time (0.5 seconds, for example) to ensure that the system controller 60 is online and the watchdog timer is active, pursuant to block 536. The DO signal also remains asserted so that the LED status light remains steady green.

The processor 408 subsequently asserts a signal called “D2” to toggle the relay 412 to position “B”. The power latch control is then transferred to the system watchdog, pursuant to block 542. The DO signal remains on so that the status light LED 434 remains steady green.

As long as the hydrogen concentration remains below the allowable level (as determined in diamond 544), then the state of the circuit 400 does not change. However, if the hydrogen concentration exceeds the allowable level, then the processor 408 performs the following actions. The processor 408 de-asserts the DO signal and switches on the D1 signal such that the status LED light 434 turns red. The processor 408 also de-asserts the D2 signal to return the relay 412 to position “A,” thereby latching power and removing control from the watchdog. The processor 408 also de-asserts the D3 signal to switch the relay 416 back to an open state, thereby pulling power from the controller 60, which then powers down. The processor 408 waits for a brief time (5 to 10 seconds) and then asserts the D2 signal to re-engage the relay 412 to switch back to position B. Because the watchdog is no longer active, the lack of the watchdog signal disengages the power latch (via the relay 412), thereby removing power from the hydrogen sensor 404, which powers down completely to a default state.

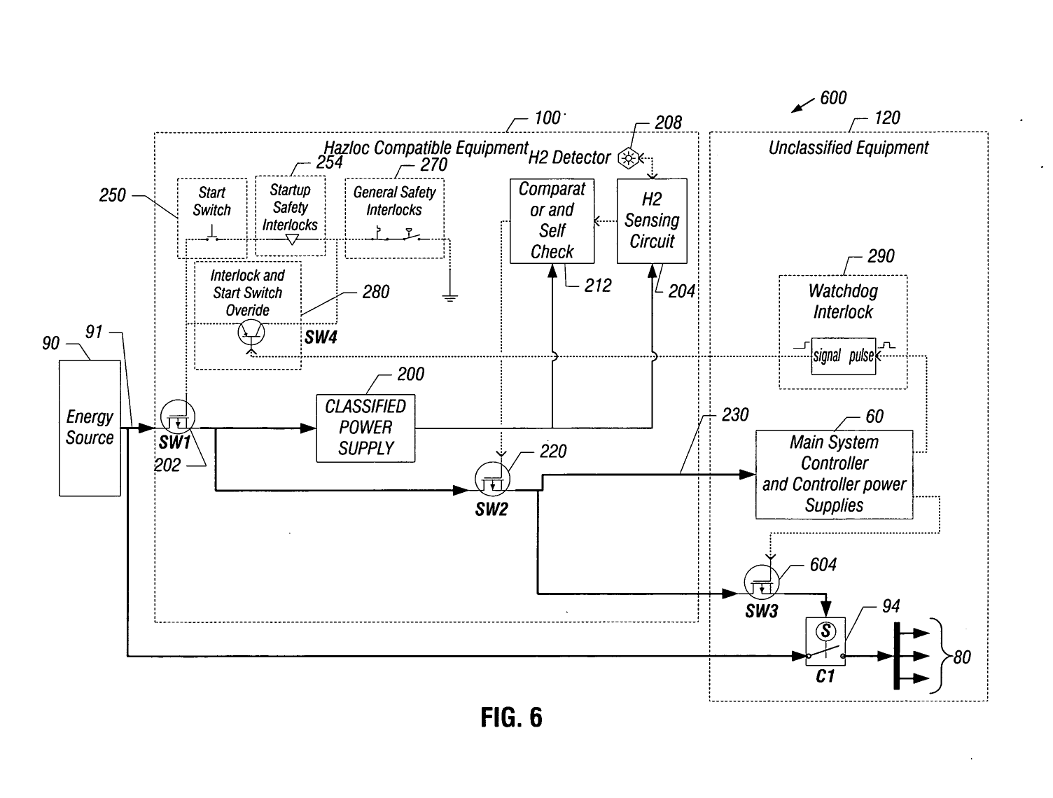

In accordance with other embodiments of the invention, the subsystems that are discussed above may be replaced by an electrical subsystem 600 that is depicted in FIG. 6. The infrastructure 600 has the same general design as the subsystem that is depicted in FIG. 2, with similar reference numerals being used, except that the electrical subsystem 600 includes an additional switch 604 (a MOSFET, for example), which allows the main system controller 60 to control when the relay 94 is closed to electrically couple the energy source 90 to the system power distribution bus 80. This is to be contrasted, for example, to the arrangement disclosed in FIG. 2 in which the relay 94 is closed in response to the closing of the switch 220. Thus, the main system controller 60 in the subsystem 600 may first receive electrical power and then make a decision as to when to power the remaining components of the unclassified equipment 120.

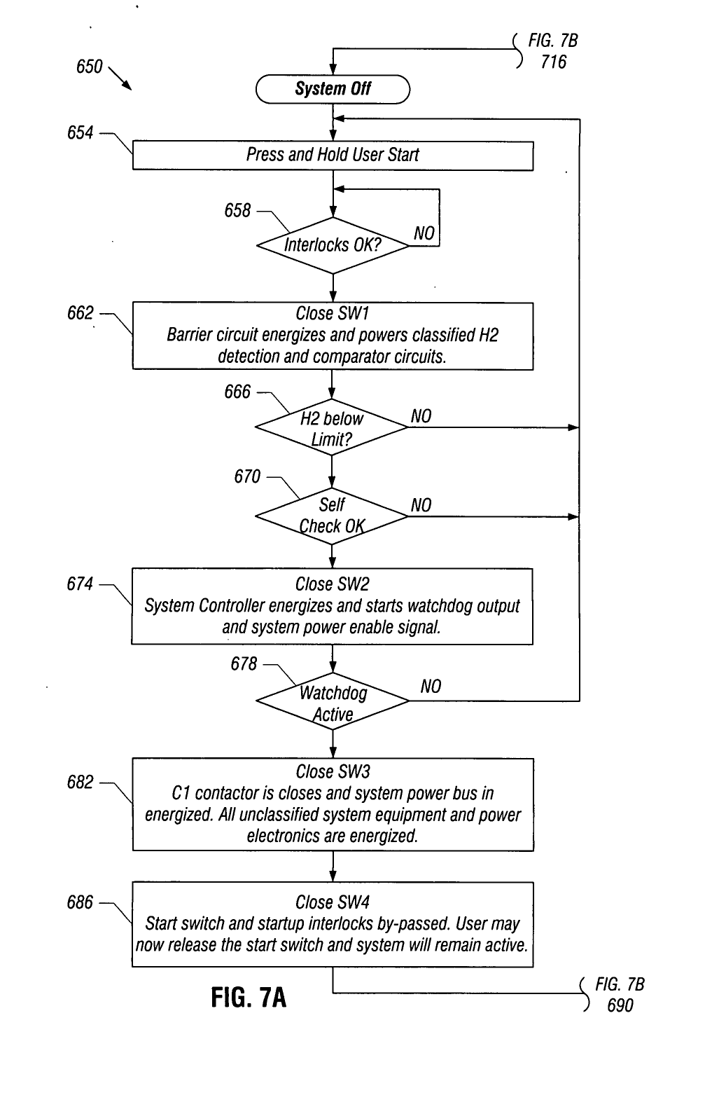

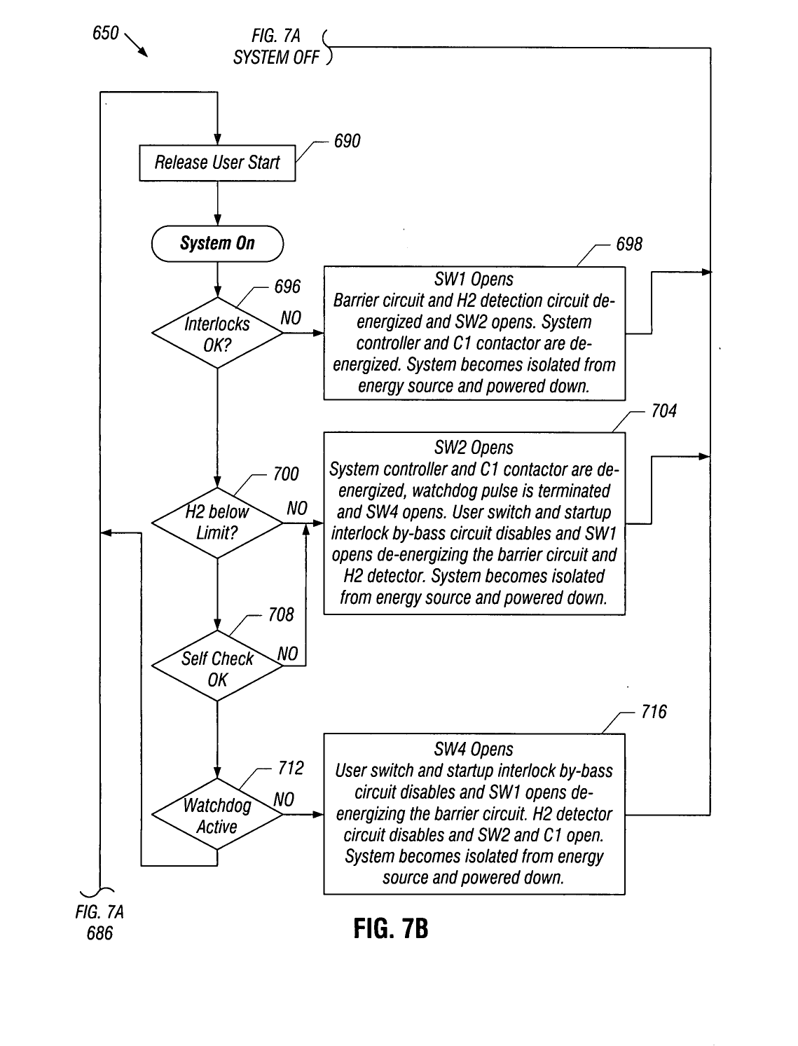

FIG. 7 generally depicts a technique 650 that may be used in connection with the electrical subsystem 600 of FIG. 6 according to some embodiments of the invention. Referring to FIG. 7 in conjunction with FIG. 6, starting from a system off state, the user start button may be pressed and held, pursuant to block 654. If the interlocks are determined (diamond 658) to be in appropriate states, then control transitions to block 662 in which the switch 202 is closed. At this point, the power supply 200 receives electrical power from the energy source 90, and thus, the comparator and self check circuit 212 as well as the hydrogen sensing circuit 204 and associated sensor 208 are powered up. If a determination is made (diamond 666) that the hydrogen gas concentration is below a predetermined limit and a determination is made (diamond 670) that the self check by the circuit 212 passes, then the switch 220 is closed, pursuant to block 674. At this point, the system controller 60 energizes and starts its watchdog output signal, which is received by the watchdog interlock 290. If a determination is made (diamond 678) that the watchdog is active, then the main system controller 60 closes the switch 604, pursuant to block 682. This causes the relay 94 to close to electrically couple the energy source 90 to the system power distribution bus 80. At this point, all unclassified system equipment and power electronics are energized.

Next, pursuant to the technique 650, due to the action of the watchdog interlock 290, the start switch and start up analogs are bypassed, pursuant to block 686. The user may then release the start switch, and the system will remain active. At this point, the user may release the start button, pursuant to block 690.

Thus, blocks 654-690 describe the procedure in which the system transitions from an off state, or shut down state, to a powered up state. Upon the occurrence of certain events, however, the system may transition back to a power down state. More specifically, pursuant to diamond 696, if the interlocks are determined not to be in appropriate states, then the switch 202 opens. At this point, the power supply 200 as well as the rest of the classified equipment 100 are de-energized, and the switch 220 opens. The system controller 60 and the relay 94 are then de-energized. Thus, both the unclassified 120 and the classified 100 equipment become isolated from the energy source 90 and are powered down, pursuant to block 698.

If either of the hydrogen concentration is above the predefined threshold (diamond 700) or the self check does not turn out to be at the appropriate levels (diamond 708), then the actions that are depicted in block 704 are performed. In particular, the switch 220 is opened, which causes the system controller 60 and relay 94 to open. As a result, the watchdog pulse is terminated, and the switch 280 opens. The user switch and start up interlock bypass circuit is then disabled, which causes the switch 202 to open to de-energize the power supply 200, the hydrogen sensing circuit 204, the comparator and self check circuit 212 and the rest of the classified equipment 100.

If the determination is made (diamond 712) that the watchdog is no longer active, then the switch 280 is opened, which opens the switch 202 and de-energizes the power supply 200. The switch 220 also opens the unclassified equipment 120 then becomes isolated from the energy source 90. Thus, the classified 100 and unclassified 120 equipment power down.

In accordance with embodiments of the invention, the components of the system 10 may be arranged pursuant to a ventilation scheme that is described in co-pending application Ser. No. ______, entitled “VENTILATION FOR FUEL CELL POWER UNIT,” (Attorney Docket No. PUG.0150), which is being filed concurrently herewith and is hereby incorporated by reference in its entirety.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A system comprising:
a first subsystem not classified to operated in a hazardous environment; and
a second subsystem classified to operate in a hazardous environment and comprising a sensor to detect a flammable gas, the second subsystem adapted to control communication of power to the first subsystem based on whether the second subsystem detects a concentration of the flammable gas exceeding a predefined threshold.

2. The system of claim 1, wherein the predefined threshold corresponds to a hydrogen concentration of approximately twenty-five percent of the Lower Flammability Limit.

3. The system of claim 1, wherein the second subsystem comprises:
a power supply classified to operate in the hazardous environment and adapted to provide power to the second subsystem when coupled to an energy source;
a first switch to selectively couple the energy source to the power supply; and
a second switch to selectively couple the energy source to the first subsystem.

4. The system of claim 3, wherein the second subsystem is adapted to operate the first switch based at least in part on a state of a user operable start switch.

5. The system of claim 3, wherein the second subsystem is adapted to operate the first switch based at least in part on states of sensors of the fuel cell system.

6. The system of claim 3, wherein the sensors comprise at least one interlock device.

7. The system of claim 3, wherein the second subsystem is adapted to operate the first switch based at least in part on a signal indicative that the first subsystem is operational after the second switch is closed.

8. The system of claim 3, wherein the second subsystem is adapted to close the second switch based at least in part on a determination that a concentration of the flammable gas exceeding the predefined threshold has not been detected.

9. The system of claim 3, wherein the second subsystem is further adapted to open the second switch in response to the concentration exceeding the predefined threshold.

10. The system of claim 3, wherein the first subsystem comprises:
a system controller to receive power when the second switch is closed, and a third switch to control communication of power from the energy source to other components of the first subsystem.

11. The system of claim 10, wherein the system controller is adapted to control whether the third switch is open or closed.

12. The system of claim 10, wherein the third switch is adapted to close in response to the closing of the second switch.

13. The system of claim 3, wherein the second subsystem further comprises:
a user activated control to activate the first switch; and
a third switch to latch the first switch closed based on a state of the first subsystem.

14. The system of claim 13, wherein the first subsystem comprises:
a system controller to generate a first signal indicative of continued operation of the system controller; and
a watchdog timer to generate a second signal to control the third switch based at least on the first signal.

15. The system of claim 1, wherein the sensor is adapted to provide a default signal indicative of a predetermined state during power up of the sensor.

16. The system of claim 1, further comprising:
a motor vehicle,
where the first and second subsystems are part of the vehicle.

17. A method usable with a fuel cell-based system, comprising:
providing a first subsystem not classified to operate in a flammable environment and providing a second subsystem classified to operate in a flammable environment; and
using the second subsystem to detect whether a concentration of the flammable gas exceeds a predefined threshold and control communication of power to the first subsystem based on the determination.

18. The method of claim 17, wherein the predefined threshold corresponds to a hydrogen concentration of approximately twenty-five percent of the Lower Flammability Limit.

19. The method of claim 17, wherein the second subsystem comprises:
a power supply classified to operate in the flammable environment and adapted to provide power to the second subsystem when coupled to an energy source;
a first switch to selectively couple the energy source to the power supply; and
a second switch to selectively couple the energy source to the first subsystem.

20. The method of claim 19, wherein the second subsystem is adapted to operate the first switch based at least in part on a state of a user operable start switch.

21. The method of claim 19, wherein the second subsystem is adapted to operate the first switch based at least in part on states of sensors of the fuel cell system.

22. The method of claim 19, wherein the second subsystem is adapted to operate the first switch based at least in part on a signal indicative that the first subsystem is operational after the second switch is closed.

23. The method of claim 19, wherein the second subsystem is adapted to close the second switch based at least in part on a determination that a concentration of the flammable gas exceeding the predefined threshold has not been detected.

24. The method of claim 19, wherein the first subsystem comprises:
a system controller to receive power when the second switch is closed, and a third switch to control communication of power from the energy source to other components of the first subsystem.

25. The method of claim 24, wherein the system controller is adapted to control whether the third switch is open or closed.

26. The method of claim 24, wherein the third switch is adapted to close in response to the closing of the second switch.

27. The method of claim 19, further comprising:
opening the second switch in response to a determination that the concentration exceeds the predefined threshold.
